(19) United States
(12) Patent Application Publication
(10) Pub. No.: US 2023/0200351 A1
(43) Pub. Date: Jun. 29, 2023

(54) ROTATING CUBE SHAPED PUZZLE PET FEEDER DEVICE

(71) Applicant: Rishi Mahtani, Hong Kong (HK)

(72) Inventor: Rishi Mahtani, Hong Kong (HK)

(21) Appl. No.: 18/175,546

(22) Filed: Feb. 28, 2023

(51) Int. Cl. A01K 5/01; A01K 15/02

(52) U.S. Cl. CPC A01K 5/0135; A01K 15/025

(57) ABSTRACT

The present invention relates to a rotating cube shaped puzzle pet feeder device for heuristically training a pet to autonomously learn, play and to obtain food. The device includes a plurality of cubic elements connected to a centrally positioned interior connecting element. The cubic elements forming a plate of cubic elements. The plate being rotatable about a horizontal and/or vertical axis of the device. One ore more cubic elements include a pullable drawer adapted to at least store a pet food item inside the pullable drawer. The pullable drawer comprises a hole allowing a pet to sniff the stored pet food item inside the pullable drawer. Pet needs to pull the drawer to get the food. The pet owner may rotate the cubic elements to put different drawers on different faces to ensure slow feeding and to let pet occupied for a longer period of time.

### TECHNICAL FIELD

The present invention herein relates to a pet feeding device, and more particularly, to a rotating cube shaped pet toy for heuristically training a pet to learn autonomously to obtain food.

### BACKGROUND

The following description includes information that may be useful in understanding the present invention. It is not an admission that any of the information provided herein is prior art or relevant to the presently claimed invention, or that any publication specifically or implicitly referenced is prior art.

As the number of people keeping pets such as cats, dogs and other animals increases, the products for pets has also be developed with more varieties. Generally speaking, such products are designed for pets for their easy use and also convenient for pet owners to clean or change. Common products of this kind include pet houses, pet beds, pet feeders, water feeders and the like.

Take pet feeders as an example, typical existing feeders are containers in a bowl-like or tray-like shape with space for receiving feed pellets and food so that the pet owner can put food in the feeder.

Engaging and training the pets have been an essential task, as pets are expected to be staying in civilized and socialized society. Thus, training and engaging with the pets is a highly researched subject matter in the art.

Boredom is also one of the concerns for the pet owners as pets get bored with the daily routine and feeding from the bowls and/or plates. So, there is a need for a well-designed pet feeder, which allows a pet to play around, not bored from its routine and keep occupied for a longer period of time.

Also, some pet feeders are designed to be slow feeders. So, pets took time to solve the puzzle or play with the pet feeders before getting the food out of it. Conventionally, as a toy, that allows a pet to be given a pill-shaped solid food such as kibble, while playing; the following types of toys have been used: a tumbler with a hole or a cylindrical container, that is, a pet toy.

The hole can be used for pet food. In and out, a rod-shaped pet toy, the rod-shaped surface has a gap for inserting pet food. The structure of these pet toys is to put pet food into the inside of the container from the hole, or give the toy to the pet after the pet food is clamped by the surface gap, the pet holds the toy or rolls the toy with the foot to get out of the hole, or take out pet food in between.

However, in this structure, since the food can be taken out without specific conditions, the pet can eat the food with less effort and quickly, which causes indigestion and other gastrointestinal problems.

In this specification if reference has been made to patent specifications, other external documents, or other sources of information, this is generally for the purpose of providing a context for discussing the features of the invention. Unless it is specifically stated otherwise, reference to such external documents is not to be construed as an admission that such documents, or such sources of information, in any jurisdiction, are prior art or form part of the common general knowledge in the art.

### SUMMARY OF THE INVENTION

In view of the above-mentioned shortcomings of pet toys according to the prior art, the purpose of the present invention is to provide an educational toy that can arouse pets' interest and fully develop their intelligence.

This objective is achieved by a rotating cube shaped puzzle pet feeder device according to the present invention. Aspects of the present invention provide a rotating cube shaped puzzle pet feeder device for heuristically training a pet to learn autonomously, and to obtain food.

According to a preferred aspect of the present invention, a rotating cube shaped puzzle pet feeder device is provided. The device includes a plurality of cubic elements connected to a centrally positioned interior connecting element. The cubic elements of each surface of the device forming a plate of cubic elements. The plate being rotatable about a horizontal and/or vertical axis of the device.

In an aspect, the food is compartmentalized and put it to the cubes in the rotating cube shaped puzzle pet feeder.

In this aspect, at least one cubic element of the cubic elements comprises of a pullable drawer adapted to at least store a pet food item inside the pullable drawer.

In this aspect, the pullable drawer comprises a hole or slots or cavity, allowing a pet to sniff the stored pet food item inside the pullable drawer.

In this aspect, at least one plate of the of cubic elements is a fixed plate having one or more slider cubic elements selected from the plurality of cubic elements, the one or more slider cubic elements has a capability of being slided.

In this aspect, the sliding of the one or more slider cubic elements enables the at least one plate to create an opening providing access inside the rotating cube shaped puzzle pet feeder device.

In this aspect, the one or more slider cubic elements are adapted to provide an arrangement of the cubic elements to provide a game platform.

In this aspect, the pullable drawer has a handle to pull the pullable drawer, wherein the handle is selected from any of combination of a rope, thread, plastic handle or a knitted net structure or combination of such.

Another aspect of the present invention provides rotating cube shaped puzzle pet feeder device that includes a plurality of elements connected to a centrally positioned interior connecting element. The elements of each surface of the device forming a plate of elements, the plate being rotatable about a spatial or horizontal and/or vertical axis of the device.

In this aspect, at least one element of the elements comprises of a pullable drawer adapted to at least store a pet food item inside the pullable drawer.

In this aspect, at least one of the elements has a shape selected from the list comprising a cube, a row of cubes, a cuboid, a trapezoid, a tetrahedron, a cylinder, a cone.

In this aspect, the elements are arranged so that the elements form a decorative pattern on each surface of the device. The decorative pattern being formed by the at least one or more colors. The decorative pattern is disturbed when the cubic elements are rearranged by random manipulation of the cubes, thereby creating a puzzle.

However, it is necessary to mention that, colors are only to entice the pet owners to buy the product for their pets. Pets need to solve the puzzle to get the food, here solving the puzzle means to play with the cubic elements and pull the drawers to look for food, not actually to put same colored cubes on one side to get the food.

The color has no bearing to “solving” the puzzle for the pet to access the food inside. Pets simply need to sniff and pull open the drawers. The owner may rotate the cube so as to change the orientation of the drawers to increase complexity and variations for the pet and to ensure slow feeding for their pets.

The purpose of a slow feeder is to avoid rapid ingestion of food by the pet which may cause gastrointestinal problems. Hence the intention of the puzzle is both to stimulate the pet (avoid boredom) and also act as a slow feeder.

Generally, larger pets have larger food requirements and at the same time, they have relatively greater power, whereas smaller pets have smaller food requirements and power. Obviously, the above-mentioned rotating cube shaped puzzle pet feeder device can well meet the different strengths of pets with different body types and the corresponding characteristics of different food requirements, and meet the “on-demand” distribution of pets of different ages, categories, and requirements.

The summary of the invention does not necessarily disclose all the features essential for defining the invention. The invention may reside in a sub-combination of the disclosed features. The various combination and sub-combination are fully described in the detailed description.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1A is a perspective view of a cube having multiple cubes arranged horizontally and vertically, in accordance with a preferred embodiment of the invention.

FIG. 1B is a schematic view of the cube of the preferred embodiment of the subject invention.

FIG. 1C is a perspective view of the cube, of the present invention, with the top plate of the cubic elements shown rotated about a spatial axis of the cube.

FIG. 1D is a top view of the cube with the top plate removed, revealing the internal connecting element, of the preferred embodiment of the subject invention.

FIG. 2 is a perspective view of a rotating cube shaped puzzle pet feeder device showing holes and handles made in accordance with the preferred embodiment of the invention.

FIGS. 3A-3C is a perspective view of the rotating cube shaped puzzle pet feeder device of the present invention, with the top plate and bottom plate of the cubic elements shown rotated about a horizontal and/or vertical axis of the cube, in accordance with the preferred embodiment of the invention.

FIGS. 4A-4B is a perspective view of a rotating cube shaped puzzle pet feeder device showing pulled drawers made in accordance with the preferred embodiment of the invention.

FIGS. 5A-5B is a perspective view of a rotating cube shaped puzzle pet feeder device showing at least one plate of the of cubic elements being a fixed plate and having one or more slider cubic elements in accordance with the embodiment of the invention.

### DETAILED DESCRIPTION OF DRAWINGS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure.

In the following description, numerous specific details are set forth in order to provide a thorough understanding of embodiments of the present invention. It will be apparent to one skilled in the art that embodiments of the present invention may be practiced without some of these specific details.

Various terms as used herein are shown below. To the extent a term used, it should be given the broadest definition persons in the pertinent art have given that term as reflected in printed publications and issued patents at the time of filing.

In view of the above-mentioned shortcomings of pet toys according to the prior art (as discussed in the background), the purpose of the present invention is to provide an educational toy that can arouse pets' interest and fully develop their intelligence.

An embodiment of the present invention provides a rotating cube shaped puzzle (interchangeably also referred to as “puzzle cube”) pet feeder device according to the present invention. More specifically, the present invention provides a rotating cube shaped puzzle pet feeder device for heuristically training a pet to learn and play autonomously to obtain food.

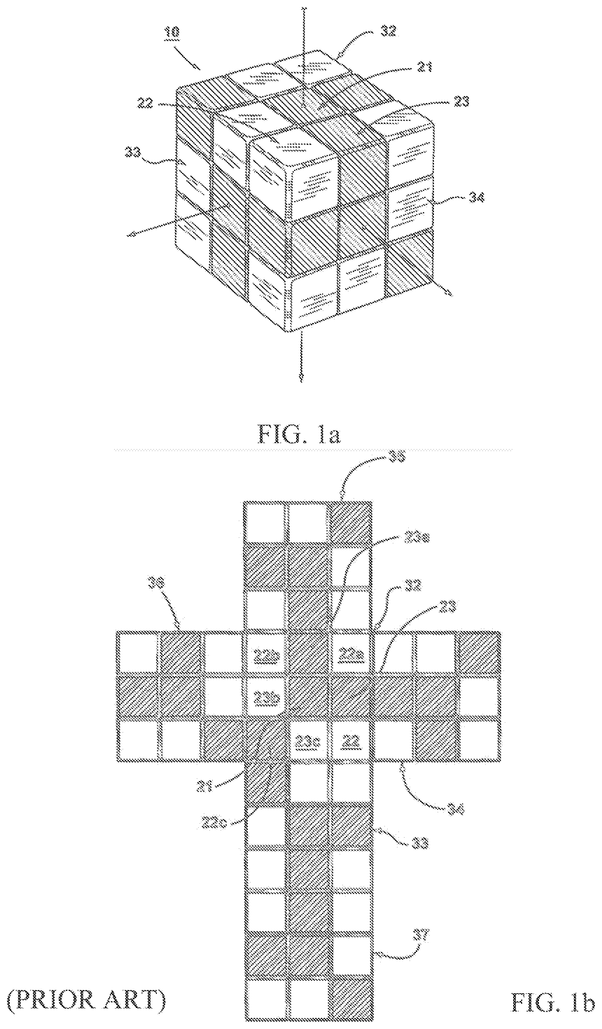

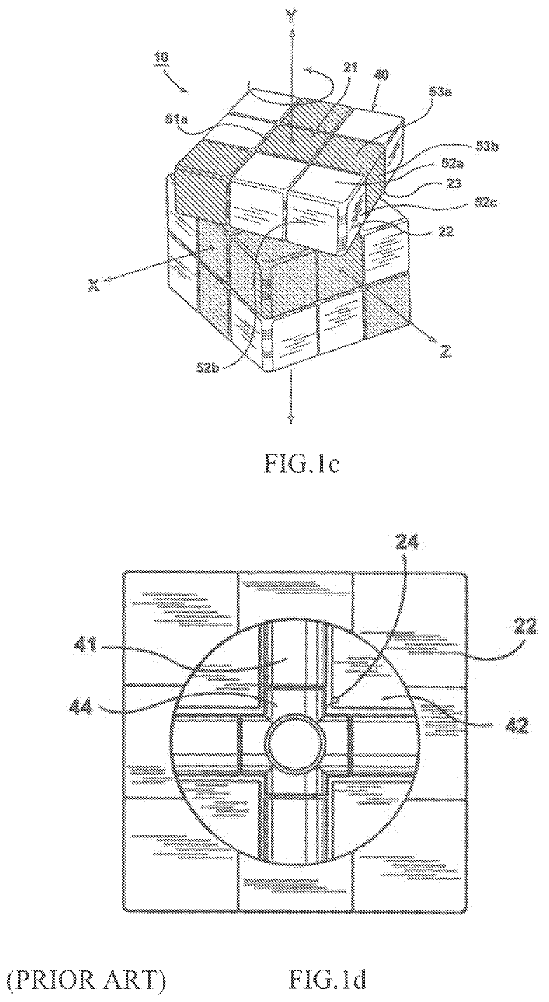

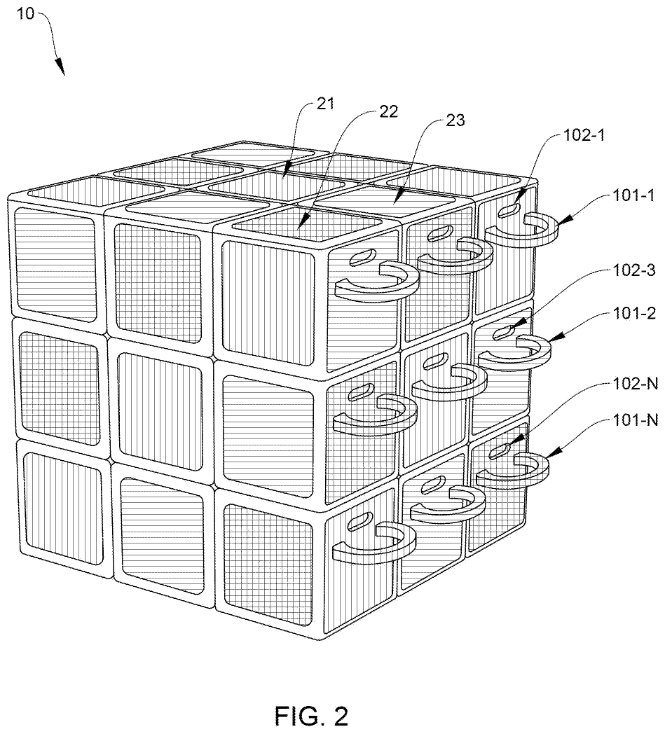

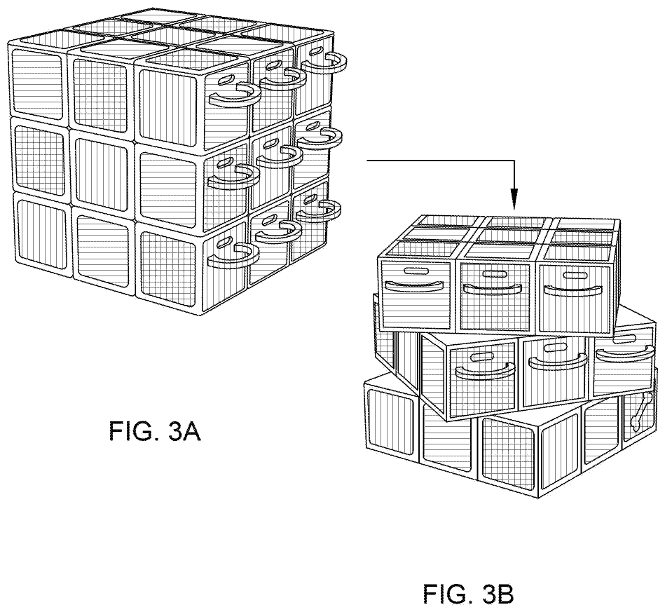

Referring now to FIGS. 1A-1D, illustrated therein is a cube 10 made in accordance with a preferred embodiment of the invention. A cube 10 is in the form of a 3×3×3 cube comprising 27 cubic elements 21, 22, 23 connected to an interior connecting element 24 (see FIG. 1D). In an example, design is cube or cuboid shaped. 2 or more levels may be present (our current design has 3 levels). Each level can rotate independently.

The mechanics of the cube 10 are preferably similar as those of a classic 3×3×3 Cube.

As in the case of a classic Cube, the 3×3 arrays of cubic elements making up each face of puzzle cube 10 form plates of cubic elements which can be rotated about the X, Y axis of the cube. As shown in FIG. 1C, top plate 40 is rotated by 45° about the Y axis of the cube.

Referring now to FIGS. 1A, 1C and 1D, as in the case of a classic Cube, the cubic elements of puzzle cube 10 take three distinct forms, namely mid-face cubic elements 21, corner cubic elements 22, and mid-face cubic elements 23. Puzzle cube 10 comprises six mid-face cubic elements 21, eight corner cubic elements 22, and 12 mid-edge cubic elements 23. Mid-face cubic elements 21 have one exposed face 51a, corner cubic elements 22 have three exposed faces 52a, 52b, and 52c, and mid-edge cubic elements 23 have two exposed faces 53a, 53b.

Mid-face cubic element 21 includes a connector 41 which is rigidly connected to a sleeve portion 44 of interior connecting element 24. Mid-face elements 21 do not change position, but merely rotate about a spatial axis, when the plates of cubic elements are rotated by a user. Corner cubic elements 22 and mid-edge cubic elements 23 have connectors 42, 43 respectively, which slidingly interconnect with interior element 24, allowing cubic elements 22 and 23 to change positions as the plates of elements are rotated by the user. In an example, each layer has a central location assembly with connecting parts; every layer can be the direction of the central axis rotation.

Referring now to FIG. 1B, the cubic elements making up the top surface 32, left-front surface 33, the right-front surface 34, the right-back surface 35, and the left-back surface 36, and the bottom surface 37 of puzzle cube 10 all have the same decorative “Y” pattern. In the case of the top surface 32 of puzzle cube 10, mid-face element 21 is red, corner elements 22, 22a and 22b are white, corner element 22c is red, mid-face elements 23 and 23 a are red, and mid-face elements 23b and 23c are white. This selection of colors produces a decorative pattern which is only visually attractive, but which also represents a pattern, in which there are three or more elements of the same color in a single row, column or diagonal.

In another embodiment, all of the exposed faces of a given cubic element of puzzle cube 10 are of same color or different color, wherein the color is selected from a group comprising at least two or more contrasting colors.

All portions of the cubic elements of puzzle cube 10 are preferably the same color, different colors and/or contrasting colors, and the cubic elements are preferably made from colored plastic. The cubic elements of puzzle cube 10 are preferably made of injection-molded plastic. The puzzle cube can have stickers or designs on different faces to attract the pet owners to buy the product.

The color tiles and the orientation of tiles is for aesthetic purposes for humans only, as similar puzzles also exist for humans which makes it cute for pet owners to buy for their pets also.

The color of each cubic element is selected to give each surface of puzzle cube 10 a distinctive decorative pattern which is appealing to the user's eye, when puzzle cube 10 is in its initial, undisturbed state.

In the preferred embodiment, the decorative pattern is for illustration only; the pet can get the food from the same or different colored cubes.

Puzzle cube 10 is preferably packaged and sold with its cubic elements in their original, undisturbed positions. In use, the plates or cubes of the puzzle cube 10 are configured be rotated by the pet for fun.

Puzzle cube 10 has a number of advantages over the classic Cube. Puzzle cube 10 is more appealing to the eye, and easier for pets to play with. The construction of puzzle cube 10 allows each of the cubic elements to be made of injection-molded plastic of a selected color, and with stickers or design to each plate of different faces of a given cubic element.

While puzzle cube 10 has a two or more color pattern, it should be understood that puzzle cubes made in accordance with the subject invention may have different decorative patterns (such as but not limited to images or embossing or engraving of designs appealing to eyes of humans and animals). Furthermore, while puzzle cube 10 has a pattern which utilizes not only two colors, but more than two colors could be utilized.

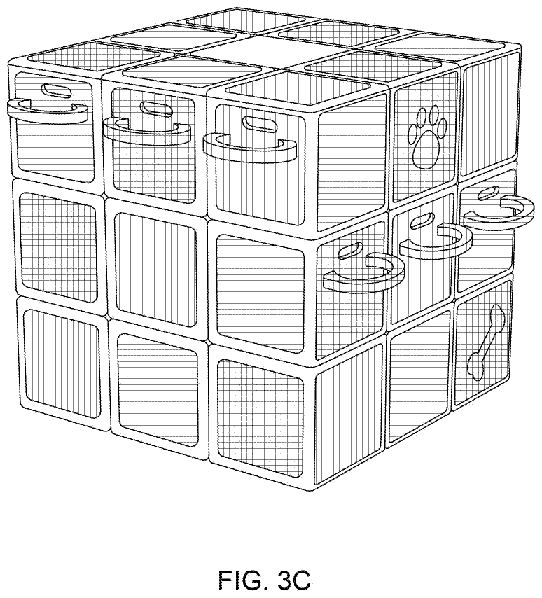

FIG. 2 is a perspective view of a rotating cube shaped puzzle pet feeder device showing holes and handles made in accordance with the preferred embodiment of the invention.

As shown in FIG. 2, in the preferred embodiment, rotating cube shaped puzzle pet feeder device 10 includes a plurality of cubic elements 21, 22, 23 connected to a centrally positioned interior connecting element 24. The cubic elements 21, 22, 23 of each surface of the device forming a plate of cubic elements. The plate being rotatable about horizontal and/or vertical axis of the device.

At least one cubic element of the cubic elements comprises of a pullable drawer (100-1, 100-2, 100-2, . . . , 100-N) adapted to at least store a pet food item inside the pullable drawer.

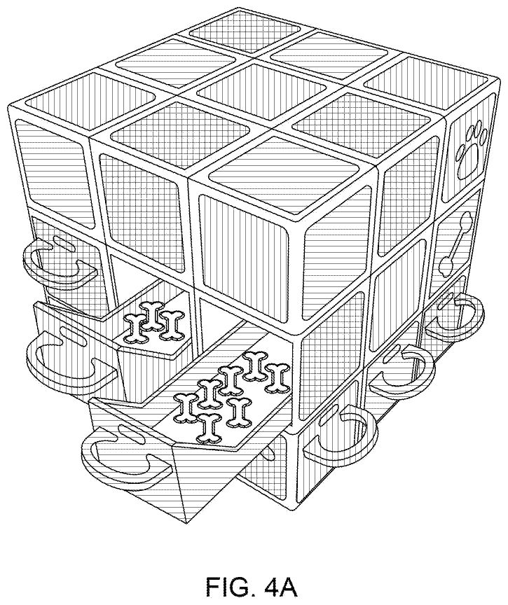

FIGS. 3A-3C is a perspective view of the rotating cube shaped puzzle pet feeder device of the present invention, with the top plate and bottom plate of the cubic elements shown rotated about a horizontal and/or vertical axis of the cube, in accordance with the preferred embodiment of the invention.

Various variations of the rotating cube shaped puzzle pet feeder device are illustrated in FIG. 3A-3C. FIG. 3A is the initial position of the rotating cube shaped puzzle pet feeder device, in which all 9 pullable drawers are on the same side of the rotating cube shaped puzzle pet feeder device, FIG. 3B is the rotated position, where the puzzle cube is rotated on the horizontal axis and FIG. 3C is the second position after the puzzle cube is rotated on the horizontal axis, in which pullable drawers are on the 3 different side of the rotating cube shaped puzzle pet feeder device.

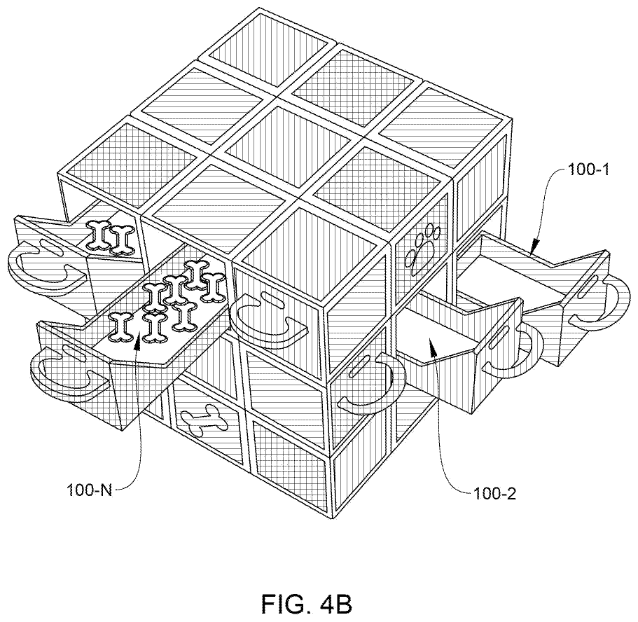

FIGS. 4A-4B is a perspective view of a rotating cube shaped puzzle pet feeder device showing pulled drawers (100-1, 100-2, 100-2, . . . , 100-N) made in accordance with the preferred embodiment of the invention. In an example, there can be nine drawers in total and each or few can be pulled out. In another example, alternate variations may also include drawers with 50% length to allow drawers on opposite sides i.e., total 18 drawers. Different drawer lengths allow different number of drawers.

Pet foods can be stored in one or more drawers of the rotating cube shaped puzzle pet feeder device to allow slow feeding and reduce boredom. The pet need to complete few steps to reach to its food.

The pullable drawer has a hole or cavity or slot (102-1, 102-2, . . . , 102-N) allowing a pet to sniff the stored pet food item inside the pullable drawer (See FIG. 2).

The pullable drawer has a handle (101-1, 101-2, . . . , 101-N) to pull the pullable drawer, wherein the handle is selected from any of combination of a rope, thread, plastic handle or a knitted net structure (See FIG. 2).

In another embodiment, one of side or all cubes on one side is configured to have same or different colors to save cost. There are no slider tiles or elements in one of the side in such embodiment.

In an exemplary embodiment, each of the cubic elements having one or more exposed faces (51a, 52a, 52b, 52c, 53a, and 53b), and whereby all of the exposed faces of a given cubic element are the same or different color, and the color being selected from a group of colors comprising at least two different colors.

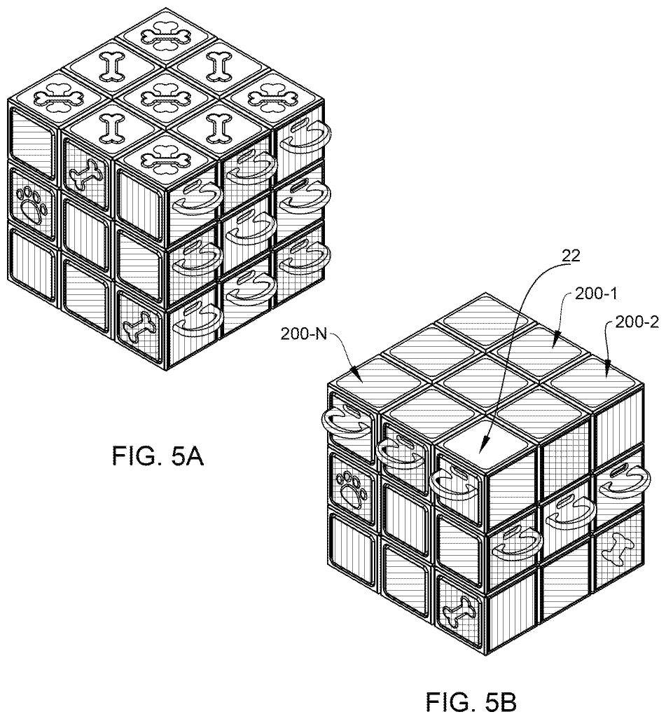

FIG. 5A is a perspective view of a rotating cube shaped puzzle pet feeder device, where the top surface having cubes with a puzzle illustrating bones shape, put to the bone shaped cavity to unlock or push the food drawer having food for the pet.

In another embodiment, the top or any other surface of rotating cube shaped puzzle pet feeder device may include one or more different puzzles. The puzzle can include but not limited to spin, slide, and rotate. Various props can also be included in other variation of the rotating cube shaped puzzle pet feeder device.

The invention is not restricted to the embodiment disclosed in the application. The puzzle shaped pet feeder can be of any shape and can have one or more puzzles on one or more surfaces of the rotating cube shaped puzzle pet feeder.

FIG. 5B is a perspective view of a rotating cube shaped puzzle pet feeder device showing at least one plate of the of cubic elements being a fixed plate and having one or more slider cubic elements in the top surface, accordance with the embodiment of the invention. In FIG. 5B, block (22) has no top plate, the top plate of other cubes can be slide to block (22). Further, one or more cubic elements (200-1, 200-2, . . . , 200-N) selected from the plurality of cubic elements, the one or more slider cubic elements (22) are slidable.

As explained above, to summarize the present invention, a rotating cube shaped puzzle pet feeder device is provided. The device includes a plurality of cubic elements connected to a centrally positioned interior connecting element. The cubic elements of each surface of the device forming a plate of cubic elements. The cubic elements of each surface of the device forming a plate of cubic elements. As compared to the conventional cubic devices, the device of the present invention includes at least one cubic element of the cubic elements comprises of a pullable drawer adapted to at least store a pet food item inside the pullable drawer.

The pullable drawer comprises a hole allowing a pet to sniff the stored pet food item inside the pullable drawer. In an example, the scent holes may be present for pets to smell what's inside.

At least one plate of the cubic elements is a fixed plate having one or more slider cubic elements selected from the plurality of cubic elements such that the one or more slider cubic elements are slidable. The sliding of the one or more slider cubic elements enables the at least one plate to create an opening providing access inside the rotating cube shaped puzzle pet feeder device.

The one or more slider cubic elements are adapted to provide an arrangement of the cubic elements to provide a game platform. In an example, the top surface may include movable tiles for additional play.

In an exemplary embodiment, the pullable drawer is a push to open drawer.

The pullable drawer is a full-length drawer such that the pullable drawer extends internally from the at least one cubic element to at least one opposite cubic element of the cubic elements.

In an exemplary embodiment, the device is a 3×3×3 cube comprising each surface of the device comprising a 3×3 array of cubic elements, the array having three rows of cubic elements, three columns of cubic elements, and three diagonals of cubic elements.

In another exemplary embodiment, the device is a 2×2×2 cube comprising each surface of the device comprising a 2×2 array of cubic elements, the array having two rows of cubic elements, two columns of cubic elements, and two diagonals of cubic elements.

In another exemplary embodiment, all portions of each of the cubic elements are formed from a material having a selected color, and the material is colored plastic.

In another exemplary embodiment, each of the cubic elements having one or more exposed faces, and whereby all of the exposed faces of a given cubic element are the same or different color, and the color being selected from a group of colors comprising at least two different colors.

In another exemplary embodiment, each cubic element is colored so that the cubic elements form a decorative pattern on each surface of the device, when the device is in an undisturbed state, the decorative pattern being formed by the at least two or different colors.

In another exemplary embodiment, the decorative pattern comprises a pattern, wherein the cubic elements making up each of the rows, the columns, and the diagonals of the array are of the same color or different color.

In another exemplary embodiment, the decorative pattern is disturbed when the cubic elements are rearranged by random manipulation of the plate, thereby creating a puzzle having drawers on different faces of the puzzle cube.

In another exemplary embodiment, at least one of the cubic elements has a shape selected from the list comprising a row of cubes, a cuboid, a trapezoid, a tetrahedron, a cylinder, a cone.

In another exemplary embodiment, the rotating cube shaped puzzle pet feeder device is a puzzle cube or a cuboid cube.

The at least one of the elements has a shape selected from the list comprising a cube, a row of cubes, a trapezoid, a tetrahedron, a cylinder, a cone.

The puzzle cube is made with food safe materials that you can trust with your pet. After the pet food compartments have been emptied, this durable puzzle cube can be hand washed with warm or cold water and mild soap.

While the subject invention is described and illustrated with respect to certain preferred and alternative embodiments, it should be understood that various modifications can be made to those embodiments without departing from the subject invention, the scope of which is defined in the following claims.

What is claimed is:

1. A rotating cube shaped puzzle pet feeder device comprising:
a plurality of cubic elements connected to a centrally positioned interior connecting element, the cubic elements of each surface of the device forming a plate of cubic elements; the plate being rotatable about horizontal and/or vertical axis of the device;
wherein at least one cubic element of the cubic elements comprises of a pullable drawer adapted to at least store a pet food item inside the pullable drawer.

2. The rotating cube shaped puzzle pet feeder device of claim 1, wherein the pullable drawer comprises a hole allowing a pet to sniff the stored pet food item inside the pullable drawer.

3. The rotating cube shaped puzzle pet feeder device of claim 1, wherein at least one plate of the of cubic elements is a fixed plate having one or more slider cubic elements in form of drawers, selected from the plurality of cubic elements, the one or more slider cubic elements are slidable.

4. The rotating cube shaped puzzle pet feeder device of claim 3, wherein sliding of the one or more cubic elements enables the at least one plate to create an opening providing access the space inside rotating cube shaped puzzle pet feeder device.

5. The rotating cube shaped puzzle pet feeder device of claim 3, wherein the one or more slider cubic elements are adapted to provide an arrangement of the cubic elements to provide a game platform.

6. The rotating cube shaped puzzle pet feeder device of claim 1, wherein the pullable drawer has a handle to pull the pullable drawer, wherein the handle is selected from any of combination of a rope, thread, plastic handle or a knitted net structure.

7. The rotating cube shaped puzzle pet feeder device of claim 1, wherein the pullable drawer is a push to open drawer.

8. The rotating cube shaped puzzle pet feeder device of claim 1, wherein the pullable drawer is a full-length drawer such that the pullable drawer extends horizontally and internally from the at least one cubic element to at least one opposite cubic element of the cubic elements.

9. The rotating cube shaped puzzle pet feeder device of claim 1, wherein the device is a 3×3×3 cube comprising each surface of the device comprising a 3×3 array of cubic elements, the array having three rows of cubic elements, three columns of cubic elements, and three diagonals of cubic elements.

10. The rotating cube shaped puzzle pet feeder device of claim 1, wherein the device is a 2×2×2 cube comprising each surface of the device comprising a 2×2 array of cubic elements, the array having two rows of cubic elements, two columns of cubic elements, and two diagonals of cubic elements.

11. The rotating cube shaped puzzle pet feeder device of claim 1, wherein all portions of each of the cubic elements are formed from a material having a selected colour, and the material is coloured plastic.

12. The rotating cube shaped puzzle pet feeder device of claim 1, wherein each of the cubic elements having one or more exposed faces, and whereby all of the exposed faces of a given cubic element are the same or different colour, and the colour being selected from a group of colours comprising at least two different colours.

13. The rotating cube shaped puzzle pet feeder device of claim 1, wherein each cubic element is coloured so that the cubic elements form a decorative pattern on each surface of the device, when the device is in an undisturbed state, the decorative pattern being formed by the at least two or more different colours.

14. The rotating cube shaped puzzle pet feeder device of claim 13, wherein the decorative pattern comprises a pattern, wherein the cubic elements making up each of the rows, the columns, and the diagonals of the array are of the same colour.

15. The rotating cube shaped puzzle pet feeder device of claim 1, wherein at least one of the cubic elements has a shape selected from the list comprising a row of cubes, a cuboid, a trapezoid, a tetrahedron, a cylinder, a cone.

16. The rotating cube shaped puzzle pet feeder device of claim 1, wherein the puzzle can be related to spin, slide, push, pull and rotate on one or more faces of the rotating cube shaped puzzle pet feeder device.

17. A rotating cube shaped puzzle pet feeder device comprising:
a plurality of elements connected to a centrally positioned interior connecting element, the elements of each surface of the device forming a plate of elements, the plate being rotatable about a horizontal and/or vertical axis of the device, wherein at least one element of the elements comprises of a pullable drawer adapted to at least store a pet food item inside the pullable drawer,
wherein at least one of the elements has a shape selected from the list comprising a cube, a row of cubes, a cuboid, a trapezoid, a tetrahedron, a cylinder, a cone, and
wherein the elements are arranged so that the elements form a decorative pattern on each surface of the device, the decorative pattern being formed by the at least two different colours, and the decorative pattern is disturbed when the cubic elements are rearranged by random manipulation of the plate, thereby creating a puzzle.
